(19) United States
(12) Patent Application Publication
(10) Pub. No.: US 2025/0246198 A1
(43) Pub. Date: Jul. 31, 2025

(54) ELECTRONIC DEVICE FOR ACQUIRING VOICE SIGNALS AND OPERATING METHOD THEREOF

(71) Applicant: Samsung Electronics Co., Ltd., Suwon-si (KR)

(72) Inventors: Soonho BAEK, Suwon-si (KR); Minseung KIM, Suwon-si (KR); Bosung KIM, Suwon-si (KR); Sangeun KIM, Suwon-si (KR); Geeyeun KIM, Suwon-si (KR); Hyunwook KIM, Suwon-si (KR); Hangil MOON, Suwon-si (KR); Kyoungho BANG, Suwon-si (KR); Gunwoo LEE, Suwon-si (KR)

(21) Appl. No.: 18/970,347

(22) Filed: Dec. 5, 2024

Related U.S. Application Data
(63) Continuation of application No. PCT/KR2024/019023, filed on Nov. 27, 2024.

(30) Foreign Application Priority Data
Jan. 31, 2024 (KR) 10-2024-0014843
Feb. 26, 2024 (KR) 10-2024-0027113

(51) Int. Cl. G10L 21/0232; G10L 21/0216; G10L 25/84; H04R 1/10; H04R 1/22; H04R 3/00

(52) U.S. Cl. CPC G10L 21/0232; G10L 25/84; H04R 1/1016; H04R 1/222; H04R 3/005; G10L 2021/02166

(57) ABSTRACT

An embodiment of the disclosure relates to an apparatus and a method for detecting voice data by an electronic device. The electronic device may include: a communication circuit, at least one processor, comprising processing circuitry, and a memory configured to store instructions, wherein at least one processor, individually or collectively, is configured to execute the instructions, and to cause the electronic device to: receive audio signals from external electronic devices, perform beamforming for a frequency band in which beamforming is possible, based on determining that the audio signals are not distorted by the beamforming, update a beamforming parameter, based on voice components or noise components included in the received audio signals, and based on determining that the audio signals are distorted by the beamforming, restrict the update of the beamforming parameter.

### CROSS-REFERENCE TO RELATED APPLICATIONS

This application is a continuation of International Application No. PCT/KR2024/019023 designating the United States, filed on Nov. 27, 2024, in the Korean Intellectual Property Receiving Office and claiming priority to Korean Patent Application Nos. 10-2024-0014843, filed on Jan. 31, 2024, and 10-2024-0027113, filed on Feb. 26, 2024, in the Korean Intellectual Property Office, the disclosures of each of which are incorporated by reference herein in their entireties.

### BACKGROUND

### Field

The disclosure relates to an electronic device for acquiring a voice signal and a method of operating the same.

### Description of Related Art

With the development of information communication technologies and semiconductor technologies, various electronic devices are being developed to multimedia devices that provide various multimedia functions. The multimedia functions may include at least one of a voice call function, a video call function, a message function, a broadcast function, a wireless Internet function, a camera function, an electronic payment function, or a content reproduction function.

The electronic device may increase user's convenience to use multimedia functions through at least one other electronic device. For example, the electronic device may output an audio signal (for example, voice and/or music) through at least one audio device. The electronic device may collect audio signals through at least one audio device.

The information may be provided as the related art to help understanding of the disclosure. No opinion or decision on whether the above-mentioned content can be applied as the prior art related to the disclosure is provided.

When a function based on a user's voice, such as a voice call, voice recording, or voice recognition, is performed, an electronic device may acquire an audio signal (for example, a voice) through at least one external electronic device. For example, the external electronic device may include a wearable device (for example, an earphone device) worn on a user's body part.

When the external electronic device is worn on a user's body part (for example, ear), the distance between at least one microphone included in the external electronic device and a user's mouth is relatively long, and thus the reception performance of voice data through the external electronic device may relatively deteriorate.

When the electronic device acquires voice data using the external electronic device, the quality of service of the voice-based function may decrease due to deterioration of the reception performance of voice data of the external electronic device.

### SUMMARY

Embodiments of the disclosure may provide an apparatus and a method for acquiring audio signals by an electronic device through a plurality of external electronic devices.

According to an example embodiment, an electronic device may include: a communication circuit, at least one processor, comprising processing circuitry, and a memory operatively connected to at least one processor. According to an example embodiment, the memory may store instructions, wherein at least one processor, individually or collectively, is configured to execute the instructions and to cause the electronic device to: receive audio signals from external electronic devices; identify, in the audio signals, a frequency band in which beamforming is possible; perform beamforming for audio signals of the frequency band in which beamforming is possible; identify whether the audio signals are distorted by the beamforming; based on determining that the audio signals are not distorted by the beamforming, update a beamforming parameter, based on voice components or noise components included in the received audio signals; and based on determining that the audio signals are distorted by the beamforming, restrict the update of the beamforming parameter.

According to an example embodiment, a method of operating an electronic device may include: receiving audio signals from a plurality of external electronic devices; identifying, in the audio signals, a frequency band in which beamforming is possible; performing beamforming for audio signals of the frequency band in which beamforming is possible; identifying whether the audio signals are distorted by the beamforming; based on determining that the audio signals are not distorted by the beamforming, updating a beamforming parameter, based on voice components or noise components included in the audio signals; and based on determining that the audio signals are distorted by the beamforming, restrict the update of the beamforming parameter.

According to an example embodiment, a non-transitory computer-readable storage medium (or computer program product) for storing one or more programs may be provided. According to an embodiment, the one or more programs may include instructions that, when individually or collectively executed by at least one processor, comprising processing circuitry, of an electronic device, cause the electronic device to: receive audio signals from a plurality of external electronic devices, identify, in the received audio signals, a frequency band in which beamforming is possible, perform beamforming for audio signals of the frequency band in which beamforming is possible, identify whether the audio signals are distorted by the beamforming, based on determining that the audio signals are not distorted by the beamforming, update a beamforming parameter, based on voice components or noise components included in the received audio signals, and based on determining that the audio signals are distorted by the beamforming, restrict the update of the beamforming parameter.

According to example embodiments of the disclosure, an electronic device may improve the quality of audio signals by acquiring the audio signals through beamforming based on the audio signals received from a plurality of external electronic devices including at least one microphone.

According to example embodiments, an electronic device may reduce distortion of audio signals by the wireless connection between the electronic device and external electronic devices by selectively updating a parameter for beamforming, based on whether the audio signals received from the plurality of external electronic devices are distorted.

Effects which can be obtained from various embodiments of the disclosure are not limited to the above-mentioned effects, and other effects which have not been mentioned may be clearly understood by those skilled in the art to which various embodiments of the disclosure belong based on the following description.

### BRIEF DESCRIPTION OF THE DRAWINGS

In connection with a description of drawings, the same or similar reference numerals may be used for the same or similar elements. Further, the above and other aspects, features and advantages of certain embodiments of the present disclosure will be more apparent from the following detailed description, taken in conjunction with the accompanying drawings, in which:

FIG. 1 is a block diagram illustrating an example electronic device within a network environment according to various embodiments;

FIG. 2 is a block diagram illustrating an example configuration of an audio module according to various embodiments;

FIG. 3 is a diagram illustrating an example of the electronic device and external electronic devices that are wirelessly connected according to various embodiments;

FIG. 4 is a block diagram illustrating example configurations of the electronic device and an external electronic device for acquiring an audio signal according to various embodiments;

FIG. 5 is a block diagram illustrating an example configuration of the external electronic device for acquiring an audio signal according to various embodiments;

FIG. 6 is a block diagram illustrating an example configuration of an audio processing circuit of the electronic device for acquiring an audio signal according to various embodiments;

FIG. 7 is a flowchart illustrating an example process in which the external electronic device acquires an audio signal according to various embodiments;

FIG. 8 is a flowchart illustrating an example process in which the electronic device acquires an audio signal according to various embodiments;

FIG. 9 is a flowchart illustrating an example process in which the electronic device identifies a frequency band in which beamforming is possible according to various embodiments;

FIG. 10 is a diagram illustrating an example of an audio signal acquired through beamforming by the electronic device according to various embodiments;

FIG. 11 is a flowchart illustrating an example process in which the electronic device updates a beamforming parameter according to various embodiments;

FIG. 12 is a diagram illustrating an example of an audio signal acquired through selective update of a beamforming parameter by the electronic device according to various embodiments; and

FIG. 13 is a diagram illustrating an example of an audio signal acquired through beamforming by the electronic device located in a first area according to

### DETAILED DESCRIPTION

The following example embodiments are described in greater detail below with reference to the accompanying drawings.

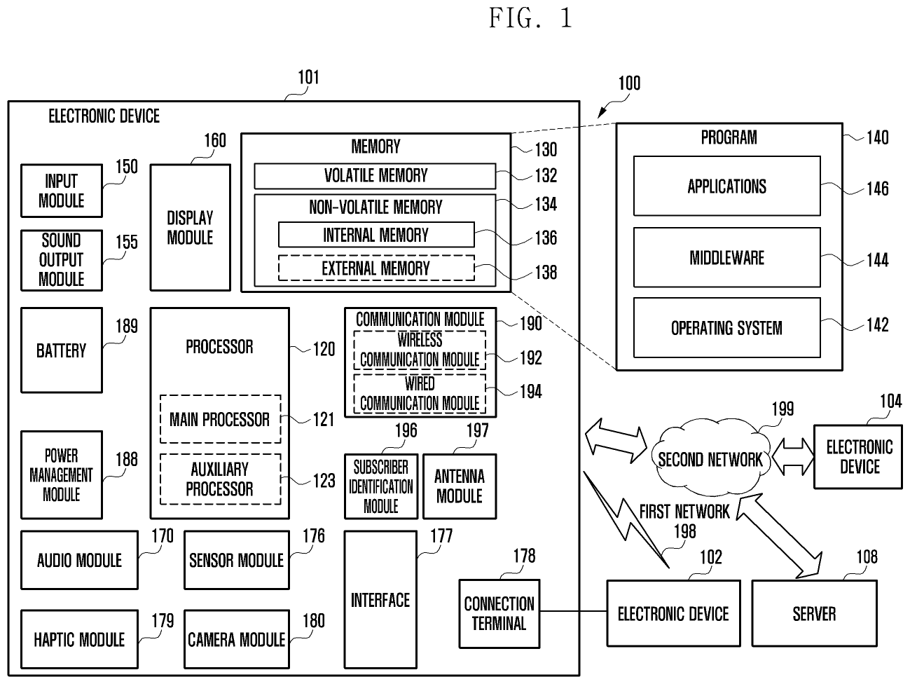

FIG. 1 is a block diagram illustrating an example electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC. According to an embodiment, the subscriber identification module 196 may include a plurality of subscriber identification modules. For example, the plurality of subscriber identification modules may store different subscriber information.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band. For example, the plurality of antennas may include patch array antennas and/or dipole array antennas.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

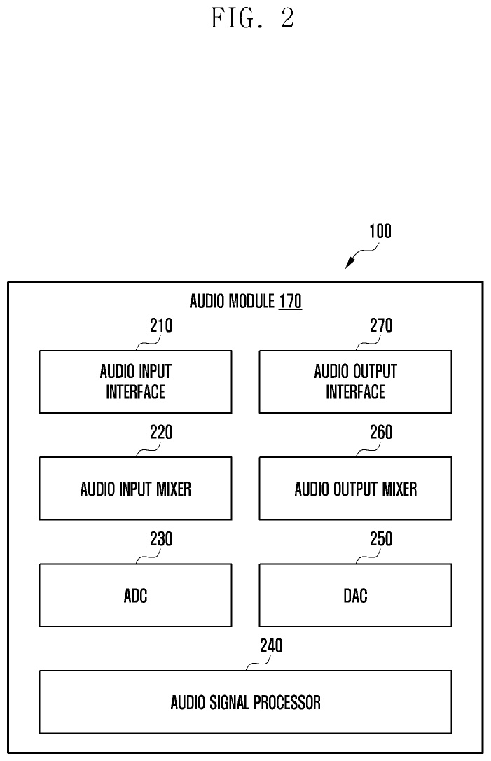

FIG. 2 is a block diagram 200 illustrating an example configuration the audio module 170 according to various embodiments. Referring to FIG. 2, the audio module 170 may include, for example, an audio input interface (e.g., including various circuitry) 210, an audio input mixer 220, an analog-to-digital converter (ADC) 230, an audio signal processor (e.g., including audio signal processing circuitry) 240, a digital-to-analog converter (DAC) 250, an audio output mixer 260, and/or an audio output interface (e.g., including various circuitry) 270.

The audio input interface 210 may include various circuitry and receive an audio signal corresponding to a sound obtained from the outside of the electronic device 101 via a microphone (e.g., a dynamic microphone, a condenser microphone, or a piezo microphone) that is configured as part of the input module 150 or separately from the electronic device 101. For example, if an audio signal is obtained from the external electronic device 102 (e.g., a headset or a microphone), the audio input interface 210 may be connected with the external electronic device 102 directly via the connecting terminal 178, or wirelessly (e.g., Bluetooth™ communication) via the wireless communication module 192 to receive the audio signal. According to an embodiment, the audio input interface 210 may receive a control signal (e.g., a volume adjustment signal received via an input button) related to the audio signal obtained from the external electronic device 102. The audio input interface 210 may include a plurality of audio input channels and may receive a different audio signal via a corresponding one of the plurality of audio input channels, respectively. According to an embodiment, additionally or alternatively, the audio input interface 210 may receive an audio signal from another component (e.g., the processor 120 or the memory 130) of the electronic device 101.

The audio input mixer 220 may synthesize a plurality of input audio signals into at least one audio signal. For example, according to an embodiment, the audio input mixer 220 may synthesize a plurality of analog audio signals input via the audio input interface 210 into at least one analog audio signal.

The ADC 230 may convert an analog audio signal into a digital audio signal. For example, according to an embodiment, the ADC 230 may convert an analog audio signal received via the audio input interface 210 or, additionally or alternatively, an analog audio signal synthesized via the audio input mixer 220 into a digital audio signal.

The audio signal processor 240 may include various audio signal processing circuitry and perform various processing on a digital audio signal received via the ADC 230 or a digital audio signal received from another component of the electronic device 101. For example, according to an embodiment, the audio signal processor 240 may perform at least one of changing a sampling rate, applying one or more filters, interpolation processing, amplifying or attenuating a whole or partial frequency bandwidth, noise processing (e.g., attenuating noise or echoes), changing channels (e.g., switching between mono and stereo), mixing, or extracting a specified signal for one or more digital audio signals. According to an embodiment, one or more functions of the audio signal processor 240 may be implemented in the form of an equalizer.

The DAC 250 may convert a digital audio signal into an analog audio signal. For example, according to an embodiment, the DAC 250 may convert a digital audio signal processed by the audio signal processor 240 or a digital audio signal obtained from another component (e.g., the processor (120) or the memory (130)) of the electronic device 101 into an analog audio signal.

The audio output mixer 260 may synthesize a plurality of audio signals, which are to be output, into at least one audio signal. For example, according to an embodiment, the audio output mixer 260 may synthesize an analog audio signal converted by the DAC 250 and another analog audio signal (e.g., an analog audio signal received via the audio input interface 210) into at least one analog audio signal.

The audio output interface 270 may include various circuitry and output an analog audio signal converted by the DAC 250 or, additionally or alternatively, an analog audio signal synthesized by the audio output mixer 260 to the outside of the electronic device 101 via the sound output module 155. The sound output module 155 may include, for example, a speaker, such as a dynamic driver or a balanced armature driver, or a receiver. According to an embodiment, the sound output module 155 may include a plurality of speakers. In such a case, the audio output interface 270 may output audio signals having a plurality of different channels (e.g., stereo channels or 5.1 channels) via at least some of the plurality of speakers. According to an embodiment, the audio output interface 270 may be connected with the external electronic device 102 (e.g., an external speaker or a headset) directly via the connecting terminal 178 or wirelessly via the wireless communication module 192 to output an audio signal.

According to an embodiment, the audio module 170 may generate, without separately including the audio input mixer 220 or the audio output mixer 260, at least one digital audio signal by synthesizing a plurality of digital audio signals using at least one function of the audio signal processor 240.

According to an embodiment, the audio module 170 may include an audio amplifier (not shown) (e.g., a speaker amplifying circuit) that is capable of amplifying an analog audio signal input via the audio input interface 210 or an audio signal that is to be output via the audio output interface 270. According to an embodiment, the audio amplifier may be configured as a module separate from the audio module 170.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

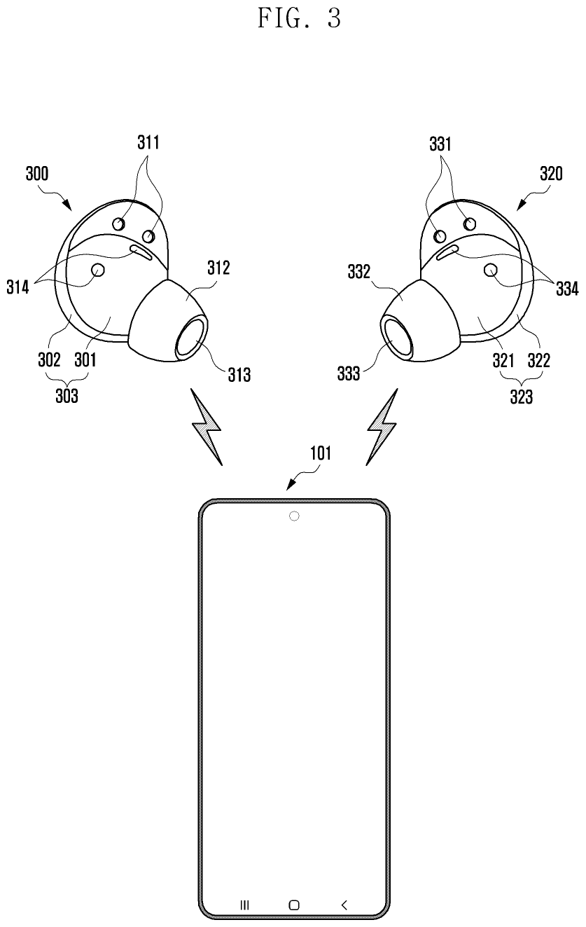

FIG. 3 is a diagram illustrating an example of an electronic device and external electronic devices that are wirelessly connected according to various embodiments. For example, an electronic device 101 of FIG. 3 may be at least partially similar to the electronic device 101 of FIG. 1 or may include various embodiments of the electronic device 101. For example, external electronic devices 300 and/or 320 of FIG. 3 may be at least partially similar to the electronic device 102 or 104 of FIG. 1 or may include various embodiments of the electronic device 102 or 104.

According to an embodiment referring to FIG. 3, the electronic device 101 may be wirelessly connected to a plurality of external electronic devices 300 and 320 that can be worn on a user's body part, based on a first communication scheme. For example, the first communication scheme may include Bluetooth, Bluetooth low energy (BLE), or a WLAN.

According to an embodiment, the plurality of external electronic devices 300 and 320 may include wireless earphones worn on different body parts of the user (for example, the right ear or the left ear) implemented in one pair.

According to an embodiment, the first external electronic device 300 may include a housing 303 including a first case 301 and a second case 302 at least partially coupled with the first case 301, and/or an ear tip 312 coupled to be removable from the housing 303. According to an embodiment, the second external electronic device 320 may include a housing 323 including a first case 321 and a second case 322 at least partially coupled with the first case 321, an ear tip 332 coupled to be removable from the housing 323, a speaker 333, a charging terminal 331 and/or a wearing detection sensor 334. In the following description, the first external electronic device 300 and the second external electronic device 320 are implemented in substantially the same way, and thus the configuration of the first external electronic device 300 is representatively described and description of the configuration of the second external electronic device 320 may be omitted.

According to an embodiment, the housing 303 of the first external electronic device 300 may be implemented in the shape that can be at least partially worn on the user's ear. For example, at least a portion of the first case 301 may physically come into contact with a body part (for example, the ear) on which the first external electronic device 300 is worn. For example, the second case 302 may be exposed to an external environment when the first external electronic device 300 is worn on the body part. For example, the ear tip 312 may be made of an elastic material (for example, rubber or silicon) having the size that can be at least partially inserted into the user's ear (external auditory meatus).

According to an embodiment, the first external electronic device 300 may include a plurality of microphones arranged in some areas of the second case 302 exposed to the external environment. For example, the plurality of microphones may include a plurality of external microphones for receiving external sound sources (or audio signals) and at least one internal microphone for acquiring user's voice speaking information.

According to an embodiment, the first external electronic device 300 may include a wearing detection sensor 314 arranged in some areas of the first case 301 (for example, the inside). For example, the wearing detection sensor 314 may be arranged in an area in which physical contact to the human body is frequently generated in the first case 301. For example, the first external electronic device 300 may determine whether the first external electronic device 300 physically comes into contact with the user's body through the wearing detection sensor 314.

According to an embodiment, the first external electronic device 300 may output sound source data to the outside through a speaker 313 arranged in an interior space of the ear tip 312.

According to an embodiment, the first external electronic device 300 may include a battery in the interior space of the housing 303. The first external electronic device 300 may charge the battery, based on a charging terminal 311 arranged in some areas of the first case 301.

According to an embodiment, when the first external electronic device 300 and the second external electronic device 320 come into contact with (or are worn on) the user's body, an audio signal acquired through a plurality of microphones (for example, external microphones) may be transmitted to the electronic device 101. For example, the first external electronic device 300 may transmit the audio signal acquired through the plurality of microphones (for example, external microphones) included in the first external electronic device 300 to the electronic device 101. For example, the audio signal transmitted to the electronic device 101 may include an audio signal beamformed based on a plurality of audio signals collected through the plurality of microphones included in the first external electronic device 300. For example, the audio signal transmitted to the electronic device 101 may include a plurality of audio signals collected through the plurality of microphones included in the first external electronic device 300.

For example, the second external electronic device 320 may transmit the audio signal acquired through the plurality of microphones (for example, external microphones) included in the second external electronic device 320 to the electronic device 101. For example, the audio signal transmitted to the electronic device 101 may include an audio signal beamformed based on a plurality of audio signals collected through the plurality of microphones included in the second external electronic device 320. For example, the audio signal transmitted to the electronic device 101 may include a plurality of audio signals collected through the plurality of microphones included in the second external electronic device 320.

According to an embodiment, the electronic device 101 may detect voice data, based on the audio signals received from the plurality of external electronic devices 300 and 320. For example, when it is determined that the plurality of external electronic devices 300 and 320 comes into contact with (or is worn on) the user's body, the electronic device 101 may detect voice data by performing beamforming based on the audio signals received from the plurality of external electronic devices 300 and 320. For example, the beamforming may be performed based on a beamforming parameter determined based on a beamforming result performed at a previous time point (or a beamforming result in a previous frame). For example, the beamforming performed at the previous time point may include beamforming for a frame right before the current beamforming is performed.

According to an embodiment, the electronic device 101 may identify whether the beamforming result is distorted. For example, when packet loss concealment (PLC) is performed for the audio signal received from at least one of the first external electronic device 300 or the second external electronic device 320, the electronic device 101 may determine that the beamforming result is distorted by packet loss. For example, when the PLC is not performed for the audio signal received from at least one of the first external electronic device 300 or the second external electronic device 320, the electronic device 101 may determine that the beamforming result is not distorted. For example, when power of an audio signal generated through the beamforming is larger than power of audio signals before the beamforming, the electronic device 101 may determine that the beamforming result is distorted by the packet loss. For example, when power of the audio signal generated through the beamforming is equal to or smaller than power of the audio signals before the beamforming, the electronic device 101 may determine that the beamforming result is not distorted.

According to an embodiment, when it is determined that the beamforming result is not distorted, the electronic device 101 may generate (or update) the beamforming parameter, based on the audio signals received from the first external electronic device 300 and the second external electronic device 320. For example, the beamforming parameter may be used for beamforming performed at the next time point (or beamforming performed in the next frame). For example, when it is determined that there is a voice in the audio signals received from the first external electronic device 300 and the second external electronic device 320, the electronic device 101 may generate (or update) the beamforming parameter, based on a covariance vector for the voice updated based on the audio signals received from the first external electronic device 300 and the second external electronic device 320. For example, the covariance vector for the voice may include an average value for a voice component included in the audio signals received from the first external electronic device 300 and the second external electronic device 320 during a predetermined time interval. For example, when it is determined that there is no voice in the audio signals received from the first external electronic device 300 and the second external electronic device 320, the electronic device 101 may generate (or update) the beamforming parameter, based on a covariance vector for noise updated based on the audio signals received from the first external electronic device 300 and the second external electronic device 320. For example, the covariance vector for the noise may include an average value for a noise component included in the audio signals received from the first external electronic device 300 and the second external electronic device 320 during a predetermined time interval.

According to an embodiment, when the beamforming result is distorted, the electronic device 101 may restrict the generation (or the update) of the beamforming parameter. For example, the electronic device 101 may restrict the use of audio signals determined to have distortion in generating (or updating) at least one of the covariance vector for the voice or the covariance vector for the noise used to generate (or update) the beamforming parameter.

According to an embodiment, the electronic device 101 may perform a function based on a voice using voice data detected through beamforming for the audio signals received from the plurality of external electronic devices 300 and 320. For example, when the electronic device 101 performs a call function with another electronic device, voice data may be transmitted to the other electronic device in which a call link is configured. For example, when a voice recording function is performed, the electronic device 101 may store (or record) the voice data. For example, when a voice recognition function is performed, the electronic device 101 may perform a function corresponding to the voice data.

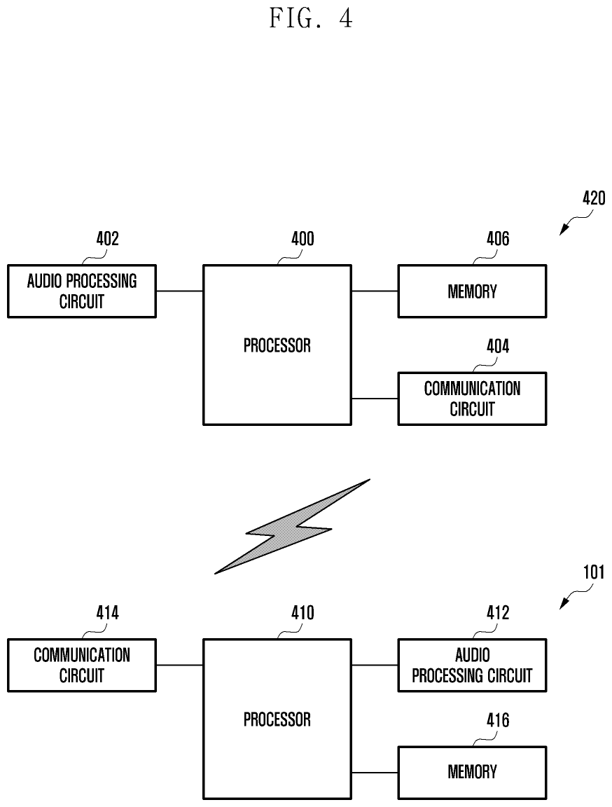

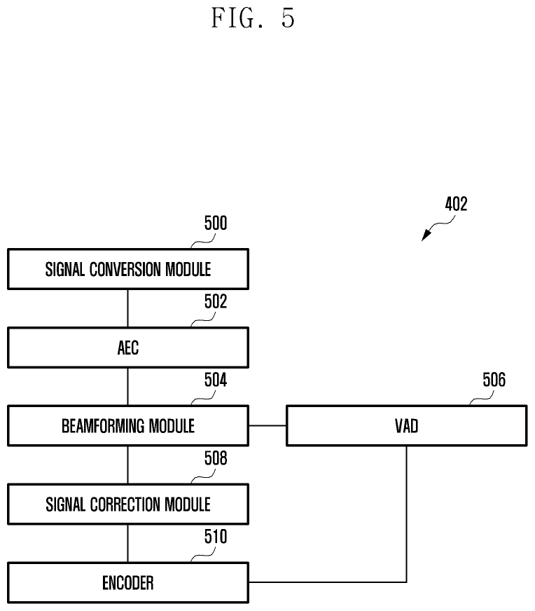

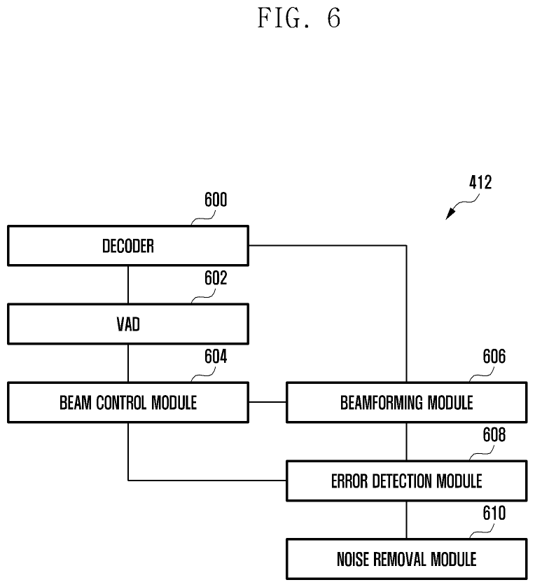

FIG. 4 is a block diagram illustrating example configurations of an electronic device and an external electronic device for acquiring an audio signal according to various embodiments. FIG. 5 is a block diagram illustrating an example configuration of an external electronic device for acquiring an audio signal according to various embodiments. FIG. 6 is a block diagram illustrating an example configuration of an audio processing circuit of an electronic device for acquiring an audio signal according to various embodiments. For example, an electronic device 101 of FIG. 4 may be at least partially similar to the electronic device 101 of FIG. 1 or 2 or may include various embodiments of the electronic device 101. For example, an external electronic device 420 of FIG. 4 may be at least partially similar to the electronic device 102 or 104 of FIG. 1 or the first external electronic device 300 or the second external electronic device 320 of FIG. 3 or may include various embodiments of the electronic device 102 or 104, the first external electronic device 300, or the second external electronic device 320.

According to an embodiment referring to FIGS. 4, 5, and 6 (which may be referred to as FIGS. 4 to 6), the external electronic device 420 may include at least one of a processor (e.g., including processing circuitry) 400, an audio processing circuit (e.g., audio processing circuitry) 402, a communication circuit (or communication circuitry) 404, and/or a memory 406. For example, the processor 400 may be substantially the same as the processor 120 of FIG. 1 or may be included in the processor 120. The audio processing circuit 402 may be substantially the same as the audio module 170 of FIG. 1 or 2 or may be included in the audio module 170. The communication circuit 404 may be substantially the same as the wireless communication module 192 of FIG. 1 or included in the wireless communication module 192. The memory 406 may be substantially the same as the memory 130 of FIG. 1 or may be included in the memory 130. For example, the processor 400 may include an application processor or a communication processor. For example, the processor 400 may be operatively, functionally, and/or electrically connected to at least one of the audio processing circuit 402, the communication circuit 404, or the memory 406. For example, the processor 400 may include at least one processor including a processing circuit. The processor 400 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the processor 400 may identify whether the external electronic device 420 comes into contact with (or is worn on) the user's body part. For example, the processor 400 may determine whether the external electronic device 420 comes into contact with (or is worn on) the user's body part through the wearing detection sensor 314 of FIG. 3.

According to an embodiment, when it is determined that the external electronic device 420 comes into contact with (or is worn on) the user's body part, the processor 400 may control the audio processing circuit 402 to acquire an external audio signal. For example, when it is determined that the external electronic device 420 comes into contact with (or is worn on) the user's body part, the processor 400 may control the audio processing circuit 402 to switch the plurality of microphones included in the external electronic device 420 to an active state.

According to an embodiment, the audio processing circuit 402 may collect external audio signals through the plurality of microphones. For example, the audio processing circuit 402 may collect external audio signals through a plurality of external microphones and/or at least one internal microphone included in the external electronic device 420.

According to an embodiment, the audio processing circuit 402 may remove an echo component in the audio signals collected through the plurality of microphones. For example, the audio processing circuit 402 (for example, a signal conversion module 500 of FIG. 5) may convert analog audio signals collected through the plurality of microphones into digital audio signals. For example, the audio processing circuit 402 (for example, AEC 502 of FIG. 5) may remove an echo component (for example, linear echo) included in digital audio signals acquired through at least one internal microphone and a plurality of external microphones. For example, the echo component may be removed through an acoustic echo cancellation (AEC).

According to an embodiment, the audio processing circuit 402 may identify whether there is a user's voice. For example, the audio processing circuit 402 (for example, VAD 506 of FIG. 5) may identify whether there is a user's voice through at least one internal microphone or an acceleration sensor of the external electronic device 420. For example, the acceleration sensor may be arranged in the side of the housing 303. For example, an internal (for example, a time interval) in which the user's voice exists may be referred to as a voice speaking interval. For example, an interval (for example, a time interval) in which no user's voice exists may be referred to as a voice non-speaking interval.

According to an embodiment, the audio processing circuit 402 may detect an audio signal through beamforming based on audio signals collected through the plurality of microphones. For example, the audio processing circuit 402 (for example, a beamforming module 504 of FIG. 5) may detect an audio signal by performing beamforming based on a beamforming parameter and audio signals collected through the plurality of external microphones. For example, the beamforming may be performed based on a data-based beamforming scheme or a generalized sidelobe canceller (GSC)-based beamforming scheme.

For example, the audio processing circuit 402 (for example, the beamforming module 504 of FIG. 5) may update the beamforming parameter, based on whether there is a voice identified through the VAD 506. For example, when it is determined that there is the voice, the beamforming parameter may be updated based on the covariance vector for the voice. For example, when it is determined that there is no voice, the beamforming parameter may be updated based on the covariance vector for the noise.

According to an embodiment, the audio processing circuit 402 may selectively correct at least some of the audio signals, based on the quality of the audio signal detected through beamforming. For example, the audio processing circuit 402 (for example, a signal correction module 508 of FIG. 5) may identify the quality for each frequency band (or for each frequency) of the audio signal detected through beamforming. For example, the quality of the audio signal may include a signal to noise ratio (SNR). For example, the audio processing circuit 402 (for example, the signal correction module 508 of FIG. 5) may apply a weighted value corresponding to the quality of the audio signal for each frequency band (or for each frequency) of the audio signal. For example, the weighted value may not be applied to some of the audio signals corresponding to a frequency band (or frequency) in which the quality of the audio signals is higher than a predetermined value. For example, the audio processing circuit 402 (for example, the signal correction module 508 of FIG. 5) may replace (or change) some of the audio signals corresponding to a frequency band (or frequency) in which the quality of the audio signals are lower than the predetermined value with (or to) audio signals collected through at least one internal microphone or an acceleration sensor. For example, the beamforming result of some of the audio signals corresponding to the frequency band (or frequency) in which the quality of the audio signals is higher than the reference value may be maintained.

According to an embodiment, the audio processing circuit 402 may control the communication circuit 404 to transmit the audio signal selectively corrected based on the quality of the audio signal and information related to the audio signal to the electronic device 101. For example, the audio processing circuit 402 (for example, an encoder 510 of FIG. 5) may encode the audio signal selectively corrected based on the quality of the audio signal according to a predetermined codec (for example, a speech codec). For example, the information related to the audio signal may be included in a reserved bit space of the encoded audio signal. For example, the information related to the audio signal may include at least one piece of information related to whether there is a voice or information related to a corrected frequency band.

According to an embodiment, the communication circuit 404 may perform wireless communication of the electronic device 101 with the external electronic device 420. For example, wireless communication may be performed based on Bluetooth, Bluetooth low energy (BLE), or WLAN.

According to an embodiment, the memory 406 may store various pieces of data used by at least one element (for example, the processor 400, the audio processing circuit 402, and/or the communication circuit 404) of the external electronic device 420. For example, the memory 406 may store various instructions that can be individually or collectively executed through the processor 400.

According to an embodiment, the external electronic device 420 may perform at least some of the operations performed by the audio processing circuit 402 through the processor 400.

According to an embodiment, the external electronic device 420 may transmit audio signals acquired through a plurality of external microphones to the electronic device 101. For example, the external electronic device 420 may remove echo components of the audio signals acquired through the plurality of external microphones and transmit the audio signals to the electronic device 101.

According to an embodiment, the electronic device 101 may include at least one of a processor (e.g., including processing circuitry) 410, an audio processing circuit (or audio processing circuitry) 412, a communication circuit (or communication circuitry) 414, and/or a memory 416. For example, the processor 410 may be substantially the same as the processor 120 of FIG. 1 or may be included in the processor 120. The audio processing circuit 412 may be substantially the same as the audio module 170 of FIG. 1 or 2 or may be included in the audio module 170. The communication circuit 414 may be substantially the same as the wireless communication module 192 of FIG. 1 or included in the wireless communication module 192. The memory 416 may be substantially the same as the memory 130 of FIG. 1 or may be included in the memory 130. For example, the processor 410 may include an application processor or a communication processor. For example, the processor 410 may be operatively, functionally, and/or electrically connected to at least one of the audio processing circuit 412, the communication circuit 414, or the memory 416. For example, the processor 410 may include at least one processor including a processing circuit. The processor 410 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the processor 410 may identify whether the external electronic device 420 (for example, the first external electronic device 300 and the second external electronic device 320 of FIG. 3) wirelessly connected to the electronic device 101 comes into contact with (or is worn on) the user's body part. For example, the processor 410 may identify whether the first external electronic device 300 and the second external electronic device 320 come into contact with (or are worn on) the user's body part, based on control information provided from the first external electronic device 300 and the second external electronic device 320.

According to an embodiment, the processor 410 may determine a voice detection scheme, based on whether the external electronic device 420 (for example, the first external electronic device 300 and the second external electronic device 320 of FIG. 3) wirelessly connected to the electronic device 101 is worn. For example, when it is determined that the external electronic device 420 (for example, the first external electronic device 300 and the second external electronic device 320 of FIG. 3) wirelessly connected to the electronic device 101 comes into contact with (or is worn on) the user's body part, the processor 410 may control the audio processing circuit 412 to detect voice data, based on the beamforming scheme. For example, when it is determined that the external electronic device 420 (for example, the first external electronic device 300 and the second external electronic device 320 of FIG. 3) wirelessly connected to the electronic device 101 does not come into contact with (or is not worn on) the user's body part, the processor 410 may control the audio processing circuit 412 to detect voice data, based on the noise removal scheme.

According to an embodiment, the audio processing circuit 412 may decode audio signals received from the external electronic device 420 (for example, the first external electronic device 300 and the second external electronic device 320 of FIG. 3) wirelessly connected to the electronic device 101. For example, the audio processing circuit 412 (for example, a decoder 600 of FIG. 6) may decode the encoded audio signal received through the first external electronic device 300 and the encoded audio signal received from the second external electronic device 320. For example, the audio processing circuit 412 (for example, the decoder 600 of FIG. 6) may synchronize the audio signal received through the first external electronic device 300 and the encoded audio signal received from the second external electronic device 320. For example, each of the audio signals received from the external electronic device 420 (for example, the first external electronic device 300 and the second external electronic device 320 of FIG. 3) may include an audio signal beamformed by the external electronic device 420 (for example, the first external electronic device 300 and the second external electronic device 320 of FIG. 3). For example, the audio signals received from the external electronic device 420 (for example, the first external electronic device 300 and the second external electronic device 320 of FIG. 3) may include audio signals collected through a plurality of microphones included in the external electronic device 420 (for example, the first external electronic device 300 and the second external electronic device 320 of FIG. 3).

For example, when there is an audio signal determined to have a packet error among the audio signal received through the first external electronic device 300 and the audio signal received from the second external electronic device 320, the audio processing circuit 412 (for example, the decoder 600 of FIG. 6) may perform packet loss concealment (PLC) for the audio signal determined to have the packet error. For example, the PLC may include a signal processing scheme for reducing deterioration of the sound quality by packet loss of the audio signal determined to have the packet error.

According to an embodiment, the audio processing circuit 412 may identify whether there is a user's voice. For example, the audio processing circuit 412 (for example, the VAD 602 of FIG. 6) may identify whether there is a user's voice in the audio signals received from the external electronic devices 300 and 320, based on information related to whether there is a voice acquired from the first external electronic device 300 and the second external electronic device 320. For example, when information indicating the existence of the voice is acquired from at least one of the first external electronic device 300 or the second external electronic device 320, the audio processing circuit 412 (for example, the VAD 602 of FIG. 6) may determine that there is the user's voice in the audio signals received from the external electronic devices 300 and 320. When information indicating the nonexistence of the voice and/or information indicating that it cannot be determined whether there is the voice is acquired from the first external electronic device 300 and the second external electronic device 320, the audio processing circuit 412 (for example, the VAD 602 of FIG. 6) may determine that there is no user's voice in the audio signals received from the external electronic devices 300 and 320.

According to an embodiment, when it is determined that the processor 410 detects voice data, based on the noise removal scheme, the audio processing circuit 412 may remove noise from the audio signal received from the external electronic device 420 (for example, the first external electronic device 300 or the second external electronic device 320 of FIG. 3) determined to be worn on the user's body. For example, the audio processing circuit 412 (for example, a noise removal module 610 of FIG. 6) may remove noise from the audio signal received from the first external electronic device 300 or the second external electronic device 320 determined to be worn on the user's body. For example, noise removal may be performed using the noise removal scheme, based on a deep neural network (DNN).

According to an embodiment, when it is determined that the processor 410 detects voice data, based on a beamforming scheme, the audio processing circuit 412 may identify a frequency band (or frequency) in which beamforming is possible in the audio signals received from the external electronic device 420 (for example, the first external electronic device 300 or the second external electronic device 320 of FIG. 3). For example, the audio processing circuit 412 (for example, a beam control module 604 of FIG. 6) may identify whether there is a corrected frequency band (or frequency) in the audio signals received from the first external electronic device 300 and the second external electronic device 320, based on information related to the corrected frequency band received from the first external electronic device 300 and the second external electronic device 320. For example, the audio processing circuit 412 (for example, the beam control module 604 of FIG. 6) may determine that a frequency band (or frequency) that is not corrected by the first external electronic device 300 and the second external electronic device 320 as the frequency band (or frequency) in which beamforming is possible. For example, the audio processing circuit 412 (for example, the beam control module 604 of FIG. 6) may determine that a frequency band (or frequency) corrected by at least one of the first external electronic device 300 or the second external electronic device 320 as a frequency band in which beamforming is restricted.

According to an embodiment, in the case of a frequency band (or frequency) in which beamforming is restricted, the audio processing circuit 412 may select one audio signal from among audio signals which correspond to the frequency band (or frequency) in which beamforming is restricted and are received from the external electronic device 420 (for example, the first external electronic device 300 and the second external electronic device 320 of FIG. 3). For example, the audio processing circuit 412 (for example, the noise removal module 610 of FIG. 6) may select an audio signal having a low noise level from among the audio signals which correspond to the frequency band (or frequency) in which beamforming is restricted and are received from the first external electronic device 300 and the second external electronic device 320 of FIG. 3. According to an embodiment, the audio processing circuit 412 (for example, the noise removal module 610 of FIG. 6) may remove noise from the selected audio signal, based on the noise level. For example, noise removal may be performed using a noise removal scheme based, for example, on a DNN.

According to an embodiment, the audio processing circuit 412 may perform beamforming, based on audio signals received from the first external electronic device 300 and the second external electronic device 320 of FIG. 3 corresponding to the frequency band (or frequency) in which beamforming is possible. For example, the audio processing circuit 412 (for example, the beamforming module 606 of FIG. 6) may detect an audio signal by performing beamforming based on the beamforming parameter and the audio signals received from the external electronic devices 300 and 320. For example, beamforming may be performed based on a data-based beamforming scheme or a generalized sidelobe canceller (GSC)-based beamforming scheme. For example, the beamforming may be performed based on the beamforming parameter determined based on a beamforming result performed at a previous time point (or a beamforming result in a previous frame). For example, the beamforming performed at the previous time point may include beamforming for a frame right before the current beamforming is performed.

According to an embodiment, the audio processing circuit 412 may identify whether the audio signal is distorted by the beamforming. For example, the audio processing circuit 412 (for example, an error detection module 608 of FIG. 6) may analyze an input and an output of the beamforming module 606 for each frequency band (or each frequency) of the audio signal. For example, beamforming by the beamforming module 606 is a processing scheme for increasing (or improving) the size of a voice component compared to the size of a noise component in the audio signal, and power of an output signal of the beamforming module 606 may become lower than power of an input signal of the beamforming module 606. When there is a frequency band (or frequency) in which power of the audio signal included in the output of the beamforming module 606 becomes higher than power of the audio signal input into the beamforming module 606 by a predetermined reference value or more, the audio processing circuit 412 (for example, the error detection module 608 of FIG. 6) may determine that the audio signal is distorted by the beamforming. For example, when there is no frequency band (or frequency) in which power of the audio signal included in the output of the beamforming module 606 becomes higher than power of the audio signal input into the beamforming module 606 by a predetermined reference value or more, the audio processing circuit 412 (for example, the error detection module 608 of FIG. 6) may determine that the audio signal is not distorted by the beamforming.

For example, the audio processing circuit 412 (for example, the error detection module 608 or the beamforming control module 604 of FIG. 6) may identify whether the audio signal is distorted by the beamforming, based on whether PLC is performed for the audio signal received from at least one of the first external electronic device 300 or the second external electronic device 320 corresponding to the frequency band in which beamforming is possible. For example, when PLC is performed for the audio signal received from at least one of the first external electronic device 300 or the second external electronic device 320, the audio processing circuit 412 (or the error detection module 608 or the beam control module 604 of FIG. 6) may determine that the audio signal is distorted by the beamforming. For example, when PLC is not performed for the audio signal received from at least one of the first external electronic device 300 or the second external electronic device 320, the audio processing circuit 412 (or the error detection module 608 or the beam control module 604 of FIG. 6) may determine that the audio signal is not distorted by the beamforming.

According to an embodiment, when it is determined that the audio signal corresponding to the frequency band in which beamforming is possible is not distorted, the audio processing circuit 412 (for example, the beam control module 604 of FIG. 6) may generate (or update) the beamforming parameter, based on the audio signal received from the external electronic device 420 (for example, the first external electronic device 300 and the second external electronic device 320). For example, the beamforming parameter may be used for beamforming performed at the next time point (or beamforming performed in the next frame).

For example, when it is determined that there is a voice in the audio signals received from the external electronic device 420 (for example, the first external electronic device 300 and the second external electronic device 320), the audio processing circuit 412 (for example, the beam control module 604 of FIG. 6) may generate (or update) the beamforming parameter, based on a covariance vector for the voice updated based on the audio signals received from the external electronic device 420 (for example, the first external electronic device 300 and the second external electronic device 320). For example, the covariance vector for the voice may include an average value for a voice component included in the audio signals received from the first external electronic device 300 and the second external electronic device 320 during a predetermined time interval. For example, when it is determined that there is no voice in the audio signals received from the external electronic device 420 (for example, the first external electronic device 300 and the second external electronic device 320), the audio processing circuit 412 (for example, the beam control module 604 of FIG. 6) may generate (or update) the beamforming parameter, based on a covariance vector for the noise updated based on the audio signals received from the external electronic device 420 (for example, the first external electronic device 300 and the second external electronic device 320). For example, the covariance vector for the noise may include an average value for a noise component included in the audio signals received from the first external electronic device 300 and the second external electronic device 320 during a predetermined time interval.

According to an embodiment, when it is determined that the audio signal corresponding to the frequency band in which beamforming is possible is distorted, the audio processing circuit 412 (for example, the beam control module 604 of FIG. 6) may restrict the generation (or update) of the beamforming parameter. For example, the audio processing circuit 412 (for example, the beam control module 604 of FIG. 6) may restrict the use of audio signals determined to be distorted in the generation (or update) of at least one of the covariance vector for the voice or the covariance vector for the noise used for generating (or updating) the beamforming parameter.

According to an embodiment, the audio processing circuit 412 may remove noise from the audio signal detected through beamforming. For example, the audio processing circuit 412 (for example, the noise removal module 610 of FIG. 6) may remove noise from the beamformed audio signal output from the beamforming module 606. For example, noise removal may be performed using the noise removal scheme, based on a deep neural network (DNN). For example, the audio processing circuit 412 (for example, the noise removal module 610 of FIG. 6) may remove an echo component (for example, non-linear echo) from the beamformed audio signal output from the beamforming module 606.

According to an embodiment, the audio processing circuit 412 may detect a voice in the audio signal from which noise is removed. For example, the audio processing circuit 412 may detect user's voice data in the audio signal from which noise included in an interval (for example, a voice speaking interval) determined to have a user's voice is removed.

According to an embodiment, the processor 410 may perform a function based on the voice using voice data detected based on audio signals received from the external electronic device 420 (for example, the first external electronic device 300 and the second external electronic device 320). For example, when a call function of another electronic device is performed with the electronic device 101 is performed, the processor 410 may control the communication circuit 414 to transmit voice data to the other electronic device having a configured communication link. For example, when the electronic device 101 performs a voice recording function, the processor 410 may store (or record) voice data. For example, when the electronic device 101 performs a voice recognition function, the processor 410 may perform a function corresponding to the voice data.

According to an embodiment, the communication circuit 414 may perform wireless communication of the external electronic device 420 with the electronic device 101 and wireless communication of another electronic device with the electronic device 101. For example, wireless communication with the external electronic device 420 may be performed based on Bluetooth, Bluetooth low energy (BLE), or WLAN. For example, wireless communication with another electronic device may be performed based on a 4G communication scheme (for example, long-term evolution (LTE)) or a 5G communication scheme (for example, new radio (NR)).

According to an embodiment, the memory 416 may store various pieces of data used by at least one element of the electronic device 101 (for example, the processor 410, the audio processing circuit 412, and/or the communication circuit 414). For example, the memory 416 may store various instructions that can be individually or collectively executed through the processor 410.

According to an embodiment, at least a portion of the operation performed by the audio processing circuit 412 of the electronic device 101 may be performed by the processor 410.

According to an example embodiment, an electronic device (for example, the electronic device 101 of FIG. 1, 2, 3, or 4) may include: a communication circuit (for example, the wireless communication module 192 of FIG. 1 or the communication circuit 414 of FIG. 4), at least one processor (for example, the processor 120 of FIG. 1, the audio module 170, the processor 410 of FIG. 3, or the audio processing circuit 412) comprising processing circuitry, and a memory (for example, the memory 130 of FIG. 1 or the memory 416 of FIG. 4) operatively connected to at least one processor. According to an example embodiment, the memory may store instructions, wherein at least one processor, individually or collectively, configured to execute the instructions and to cause the electronic device to: receive audio signals from external electronic devices (for example, the first external electronic device 300 and the second external electronic device 320 of FIG. 3, or the external electronic device 420 of FIG. 4; identify, in the audio signals, a frequency band in which beamforming is possible; perform beamforming for audio signals of the frequency band in which beamforming is possible; identify whether the audio signals are distorted by the beamforming; based on determining that the audio signals are not distorted by the beamforming, update a beamforming parameter, based on voice components or noise components included in the received audio signals; and based on determining that the audio signals are distorted by the beamforming, restrict the update of the beamforming parameter.

According to an example embodiment, the beamforming parameter may be used for beamforming of an audio signal performed in a next time interval (or next frame).

According to an example embodiment, at least one processor, individually and/or collectively, may be configured to execute the instructions, and to cause the electronic device to: based on a packet loss concealment (PLC) operation for the audio signals of the frequency band in which beamforming is possible being performed, determine that the audio signals are distorted by the beamforming; and based on the PLC operation for the audio signals of the frequency band in which beamforming is possible not being performed, determine that the audio signals are not distorted by the beamforming.

According to an example embodiment, at least one processor, individually or collectively, may be configured to execute the instructions, and to cause the electronic device to: based on determining that that power of the audio signals increases based on a beamforming result, determine that the audio signals are distorted by the beamforming; and based on determining that power of the audio signals decreases based on the beamforming result, determine that the audio signals are not distorted by the beamforming.

According to an example embodiment, at least one processor, individually or collectively, may be configured to execute the instructions, and to cause the electronic device to: based on determining that the external electronic devices are worn on a user's body part, identify the frequency band in which beamforming is possible in audio signals received from the external electronic devices.

According to an example embodiment, at least one processor, individually or collectively, may be configured to execute the instructions, and to cause the electronic device to: identify, in the beamformed audio signals received from each of the external electronic devices, whether there is a frequency band updated based on another audio signal, based on a control signal received from the external electronic devices; determine the frequency band updated based on the another audio signal as a frequency band in which beamforming is restricted; and determine a frequency band that is not updated based on the another audio signal as the frequency band in which beamforming is possible.

According to an example embodiment, at least one processor, individually or collectively, is configured to execute the instructions, and to cause the electronic device to: remove and noise from the audio signals in the frequency band in which beamforming is restricted and the beamforming result (e.g., audio signals detected using beamforming) for the frequency band in which beamforming is possible; and remove echo components from the audio signals from which the noise is removed.

According to an example embodiment, at least one processor, individually or collectively, may be configured to execute the instructions, and to cause the electronic device to: based on determining that the audio signals are not distorted by the beamforming, identify whether a specified interval for the beamforming is a voice generation interval, based on a control signal received from the external electronic devices; based on the specified interval for the beamforming being the voice generation interval, update a parameter related to the beamforming, based on the voice components included in the received audio signals; and based on the specified interval for the beamforming not being the voice generation interval, update the parameter related to the beamforming, based on the noise components included in the received audio signals.

According to an example embodiment, the external electronic devices may include a pair of wearable devices (for example, earphones).

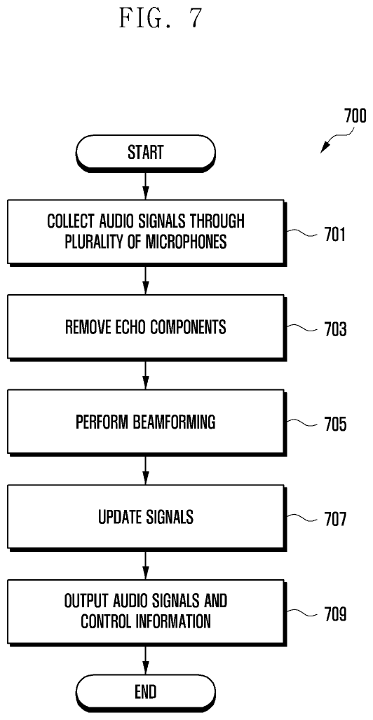

FIG. 7 is a flowchart 700 illustrating an example process in which an external electronic device acquires an audio signal according to various embodiments. In the following description, respective operations may be sequentially performed but the sequential performance is not necessary. For example, orders of the operations may be changed, and at least two operations may be performed in parallel. For example, the external electronic device of FIG. 7 may be the external electronic device 300, 320, or 420 of FIG. 1, 2, 3, or 4.

According to an embodiment referring to FIG. 7, the external electronic device (for example, the first external electronic device 300 and/or the second external electronic device 320 of FIG. 3) may collect external audio signals through a plurality of microphones of the external electronic device in operation 701. For example, when it is determined that the first external electronic device 300 (or the second external electronic device 320) comes into contact with (or is worn on) a user's body part, the processor 400 may control the audio processing circuit 402 to acquire external audio signals. The audio processing circuit 402 may collect external audio signals through (or using) a plurality of external microphones and/or at least one internal microphone included in the first external electronic device 300 (or the second external electronic device 320).

According to an embodiment, the external electronic device (for example, the first external electronic device 300 and/or the second external electronic device 320 of FIG. 3) may remove echo components from the audio signals collected through the plurality of microphones in operation 703. For example, the audio processing circuit 402 (for example, AEC 502 of FIG. 5) may remove echo components (for example, liner echo) included in the audio signals acquired through at least one internal microphone and the plurality of external microphones. For example, the echo component may be removed through an acoustic echo cancellation (AEC).

According to an embodiment, the external electronic device (for example, the first external electronic device 300 and/or the second external electronic device 320 of FIG. 3) may perform beamforming based on the audio signals in operation 705. For example, the audio processing circuit 402 (for example, a beamforming module 504 of FIG. 5) may detect an audio signal by performing beamforming based on a beamforming parameter and audio signals collected through the plurality of external microphones. For example, beamforming may be performed based on a data-based beamforming scheme or a generalized sidelobe canceller (GSC)-based beamforming scheme. For example, the beamforming parameter may include a beamforming parameter generated (or updated) based on a beamforming result performed at the previous time point.

For example, the audio processing circuit 402 (for example, VAD 506 of FIG. 5) may identify whether there is a user's voice through at least one internal microphone or an acceleration sensor of the external electronic device 300. For example, the audio processing circuit 402 (for example, the beamforming module 504 of FIG. 5) may generate (or update) the beamforming parameter, based on whether there is a voice identified through the VAD 506. For example, when it is determined that there is the voice, the beamforming parameter may be generated (or updated) based on a covariance vector for the voice. For example, when it is determined that there is no voice, the beamforming parameter may be generated (or updated) based on a covariance vector for noise.

According to an embodiment, the external electronic device (for example, the first external electronic device 300 and/or the second external electronic device 320 of FIG. 3) may selectively update (or correct) at least a portion of the audio signal, based on the quality of the audio signal detected through beamforming in operation 707. For example, the audio processing circuit 402 (for example, a signal correction module 508 of FIG. 5) may identify the quality for each frequency band of the audio signal detected through beamforming. For example, the quality of the audio signal may include a signal to noise ratio (SNR). For example, the audio processing circuit 402 (for example, a signal correction module 508 of FIG. 5) may apply a weighted value corresponding to the quality of the audio signal for each frequency band of the audio signal. For example, the weighted value may not be applied to some of the audio signals corresponding to a frequency band in which the quality of the audio signals is higher than a predetermined reference value. For example, the audio processing circuit 402 (for example, the signal correction module 508 of FIG. 5) may replace some of the audio signals corresponding to a frequency band in which the quality of the audio signals are lower than the predetermined value with audio signals collected through at least one internal microphone or an acceleration sensor. For example, the beamforming result of some of the audio signals corresponding to the frequency band in which the quality of the audio signals is lower than the reference value may be maintained.

According to an embodiment, the external electronic device (for example, the first external electronic device 300 and/or the second external electronic device 320 of FIG. 3) may transmit (or output) the audio signal selected corrected based on the quality of the audio signal and information related to the audio signal to the electronic device 101 in operation 709. For example, the audio processing circuit 402 (for example, an encoder 510 of FIG. 5) may encode the audio signal selectively corrected based on the quality of the audio signal according to a predetermined codec (for example, a speech codec). For example, the information related to the audio signal may be included in a reserved bit space of the encoded audio signal. For example, the information related to the audio signal may include at least one piece of information related to whether there is a voice or information related to a corrected frequency band.

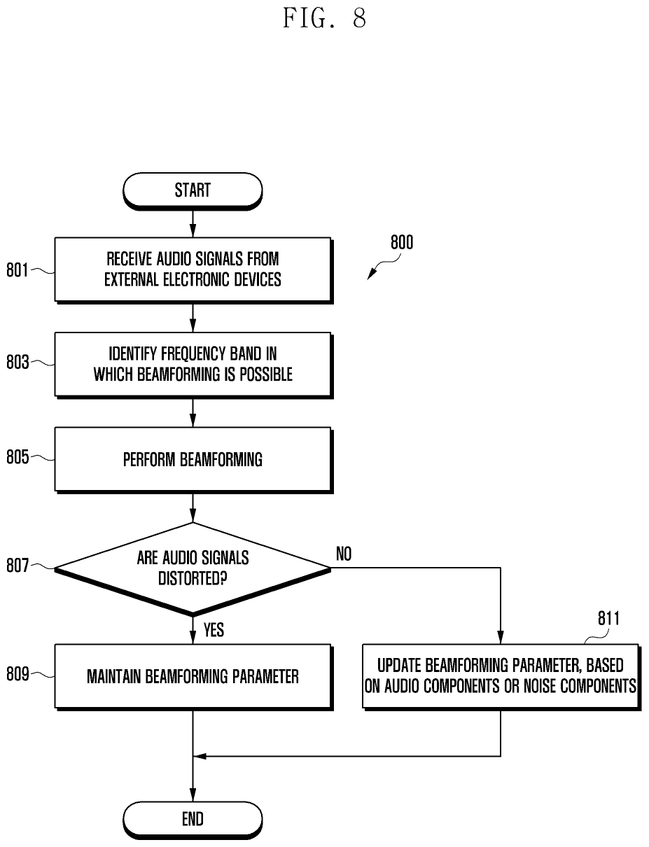

FIG. 8 is a flowchart 800 illustrating an example process in which the electronic device acquires an audio signal according to various embodiments. In the following description, respective operations may be sequentially performed but the sequential performance is not necessary. For example, orders of the operations may be changed, and at least two operations may be performed in parallel. For example, the electronic device of FIG. 8 may be the electronic device 101 of FIG. 1, 2, 3, or 4.

According to an embodiment referring to FIG. 8, the electronic device (for example, the electronic device 101) may receive audio signals from external electronic devices (for example, the first external electronic device 300 and the second external electronic device 320 of FIG. 3 or the external electronic device 420 of FIG. 4) wirelessly connected to the electronic device 101 in operation 801. For example, the audio processing circuit 412 (for example, a decoder 600 of FIG. 6) may decode the encoded audio signal received through the first external electronic device 300 and the encoded audio signal received from the second external electronic device 320. For example, the audio processing circuit 412 (for example, the decoder 600 of FIG. 6) may synchronize the audio signal received through the first external electronic device 300 and the encoded audio signal received from the second external electronic device 320. For example, the audio signals received from the external electronic devices (for example, the first external electronic device 300 and the second external electronic device 320 of FIG. 3) may include an audio signal beamformed by each of the external electronic devices. For example, the audio signals received from the external electronic devices (for example, the first external electronic device 300 and the second external electronic device 320 of FIG. 3) may include audio signals collected through a plurality of microphones included in each of the external electronic devices.

For example, when there is an audio signal determined to have a packet error among the audio signal received through the first external electronic device 300 and the audio signal received from the second external electronic device 320, the audio processing circuit 412 (for example, the decoder 600 of FIG. 6) may perform packet loss concealment (PLC) for the audio signal determined to have the packet error. For example, the PLC may include a signal processing scheme for reducing deterioration of the sound quality by packet loss of the audio signal determined to have the packet error.

According to an embodiment, the electronic device 101 may identify a frequency band in which beamforming is possible in the audio signals received from the external electronic devices (for example, the first external electronic device 300 and the second external electronic device 320 of FIG. 3) in operation 803. For example, the processor 410 may identify whether the first external electronic device 300 and the second external electronic device 320 come into contact with (or are worn on) the user's body part, based on control information provided from the first external electronic device 300 and the second external electronic device 320. For example, when it is determined that the external electronic devices (for example, the first external electronic device 300 and the second external electronic device 320 of FIG. 3) wirelessly connected to the electronic device 101 come into contact with (or are worn on) the user's body part, the processor 410 may control the audio processing circuit 412 to detect voice data, based on a beamforming scheme. For example, when it is determined that at least one of the external electronic devices (for example, the first external electronic device 300 and the second external electronic device 320 of FIG. 3) wirelessly connected to the electronic device 101 does not come into contact with (or is not worn on) the user's body part, the processor 410 may control the audio processing circuit 412 to detect voice data, based on a noise removal scheme.

For example, when it is determined that the processor 410 detects voice data, based on a beamforming scheme, the audio processing circuit 412 (for example, the beam control module 604 of FIG. 6) may identify a frequency band in which beamforming is possible in the audio signals received from the external electronic devices (for example, the first external electronic device 300 and the second external electronic device 320 of FIG. 3). For example, the audio processing circuit 412 (for example, a beam control module 604 of FIG. 6) may identify whether there is a corrected frequency band (or frequency) in the audio signals received from the first external electronic device 300 and the second external electronic device 320, based on information related to the corrected frequency band received from the first external electronic device 300 and the second external electronic device 320. For example, the audio processing circuit 412 (for example, the beam control module 604 of FIG. 6) may determine that a frequency band (or frequency) that is not corrected by the first external electronic device 300 and the second external electronic device 320 as the frequency band (or frequency) in which beamforming is possible. For example, the audio processing circuit 412 (for example, the beam control module 604 of FIG. 6) may determine that the frequency band (or frequency) corrected by at least one of the first external electronic device 300 or the second external electronic device 320 is a frequency band in which beamforming is restricted.

According to an embodiment, the electronic device 101 may perform beamforming for audio signals received from the external electronic devices (for example, the first external electronic device 300 and the second external electronic device 320 of FIG. 3) corresponding to the frequency band (or frequency) in which beamforming is possible in operation 805. For example, beamforming may be performed based on a data-based beamforming scheme or a generalized sidelobe canceller (GSC)-based beamforming scheme. For example, the beamforming may be performed based on a beamforming parameter determined based on a beamforming result performed at a previous time point. For example, the beamforming performed at the previous time point may include beamforming for a frame right before the current beamforming is performed.

According to an embodiment, the electronic device 101 may identify whether the audio signal is distorted by beamforming in operation 807. For example, when PLC is performed for the audio signal received from at least one of the first external electronic device 300 or the second external electronic device 320, the audio processing circuit 412 (for example, the beam control module 604 or the error detection module 608 of FIG. 6) may determine that the audio signal is distorted by beamforming. When PLC is not performed for the audio signal received from at least one of the first external electronic device 300 or the second external electronic device 320, the audio processing circuit 412 (for example, the beam control module 604 or the error detection module 608 of FIG. 6) may determine that the audio signal is not distorted by beamforming.

For example, when there is a frequency band (or frequency) in which power of the audio signal included in the output of the beamforming module 606 becomes higher than power of the audio signal input into the beamforming module 606 by a the error detection module 608 of FIG. 6) may determine that the audio signal is distorted by beamforming. For example, when there is no frequency band (or frequency) in which power of the audio signal included in the output of the beamforming module 606 becomes higher than power of the audio signal input into the beamforming module 606 by a predetermined reference value or more, the audio processing circuit 412 (for example, the error detection module 608 of FIG. 6) may determine that the audio signal is not distorted by beamforming.

According to an embodiment, when it is determined that the audio signal is distorted by beamforming (for example, “Yes” of operation 807), the electronic device 101 may maintain the beamforming parameter determined at the previous time point in operation 809. For example, the audio processing circuit 412 (for example, the beam control module 604 of FIG. 6) may restrict the use of audio signals determined to be distorted in the generation (or update) of at least one of the covariance vector for the voice or the covariance vector for the noise used for generating (or updating) the beamforming parameter.

According to an embodiment, when it is determined that the audio signal is not distorted by beamforming (for example, “No” of operation 807), the electronic device 101 may update (or generate) the beamforming parameter, based on audio signals received from the external electronic devices (for example, the first external electronic device 300 and the second external electronic device 320 of FIG. 3). For example, when it is determined that the audio signal is not distorted by beamforming, the audio processing circuit 412 (for example, the beam control module 604 of FIG. 6) may update (or generate) the beamforming parameter, based on audio signals received from the first external electronic device 300 and the second external electronic device 320.

For example, when it is determined that there is a voice in the audio signals received from the first external electronic device 300 and the second external electronic device 320, the audio processing circuit 412 (for example, the beam control module 604 of FIG. 6) may update (or generate) the beamforming parameter, based on the covariance vector for the voice updated based on the audio signals received from the first external electronic device 300 and the second external electronic device 320. For example, the covariance vector for the voice may include an average value for a voice component included in the audio signals received from the first external electronic device 300 and the second external electronic device 320 during a predetermined time interval. For example, when it is determined that there is no voice in the audio signals received from the first external electronic device 300 and the second external electronic device 320, the audio processing circuit 412 (for example, the beam control module 604 of FIG. 6) may update (or generate) the beamforming parameter, based on the covariance vector for the noise updated based on the audio signals received from the first external electronic device 300 and the second external electronic device 320. For example, the covariance vector for the noise may include an average value for a noise component included in the audio signals received from the first external electronic device 300 and the second external electronic device 320 during a predetermined time interval.

According to an embodiment, the electronic device 101 may perform beamforming at the next time point (or beamforming in the next frame) using the beamforming parameter selectively updated based on the beamforming result.

According to an embodiment, the electronic device 101 may detect voice data

in the audio signal detected through beamforming. For example, the audio processing circuit 412 (for example, the noise removal module 610 of FIG. 6) may remove noise from the beamformed audio signal output from the beamforming module 606. For example, noise removal may be performed using the noise removal scheme, based on a deep neural network (DNN). For example, the audio processing circuit 412 (for example, the noise removal module 610 of FIG. 6) may remove an echo component (for example, non-linear echo) from the beamformed audio signal output from the beamforming module 606. For example, the audio processing circuit 412 may detect user's voice data in the audio signal from which noise included in an interval (for example, a voice speaking interval) determined to have a user's voice is removed.

According to an embodiment, when it is determined that voice data is detected based on the noise removal scheme, the electronic device 101 may remove noise from the audio signal received from the external electronic device (for example, the first external electronic device 300 or the second external electronic device 320 of FIG. 3) determined to be worn on the user's body. The electronic device 101 may detect user's voice data in the audio signal from which noise included in the interval (for example, voice speaking interval) determined to have a user's voice is removed.

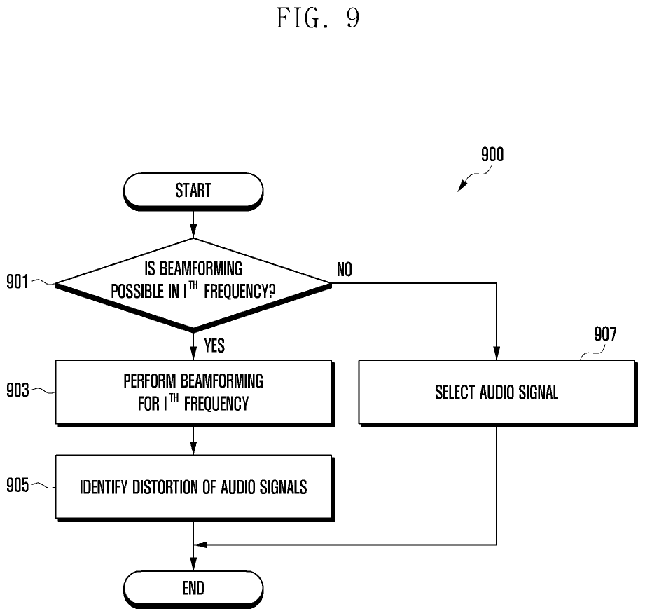

FIG. 9 is a flowchart 900 illustrating an example process in which the electronic device identifies a frequency band in which beamforming is possible according to various embodiments. For example, at least some of FIG. 9 may include the detailed operations of operations 803 and 805 of FIG. 8. In the following description, respective operations may be sequentially performed but the sequential performance is not necessary. For example, orders of the operations may be changed, and at least two operations may be performed in parallel. For example, the electronic device of FIG. 9 may be the electronic device 101 of FIG. 1, 2, 3, or 4.

According to an embodiment referring to FIG. 9, when receiving audio signals from external electronic devices (for example, the first external electronic device 300 and the second external electronic device 320 of FIG. 3 or the external electronic device 420 of FIG. 4) wirelessly connected to the electronic device 101 (for example, operation 801 of FIG. 8), the electronic device (for example, the electronic device 101) may identify whether beamforming is possible in an i^{th} frequency (or an i^{th} frequency band) in operation 901. For example, when it is determined that the first external electronic device 300 and the second external electronic device 320 wirelessly connected to the electronic device 101 come into contact with (are worn on) the user's body part, the audio processing circuit 412 (for example, the beam control module 604 of FIG. 6) may identify whether beamforming is possible in the i^{th} frequency (or the i^{th} frequency band) within the audio signals received from the external electronic devices 300 and 320. For example, the i^{th} frequency (or the i^{th} frequency band) may indicate a partial frequency (or a partial frequency band) of the frequencies (or frequency bands) included in the audio signals in a predetermined time interval (for example, frame) received from the external electronic devices 300 and 320 by the electronic device 101. For example, i is an index indicating frequencies (or frequency bands) included in the audio signal, and may include 0 and a natural number.

For example, when the audio signal of the i^{th} frequency (or i^{th} frequency band) is corrected based on information related to the corrected frequency band received from the first external electronic device 300 and the second external electronic device 320, the audio processing circuit 412 (for example, the beam control module 604 of FIG. 6) may determine that beamforming for the i^{th} frequency (or i^{th} frequency band) is not performed. For example, the state in which it is determined that the audio signal in the i^{th} frequency (or i^{th} frequency band) is corrected may include the state in which at least one of the audio signal in the i^{th} frequency (or i^{th} frequency band) received from the first external electronic device 300 or the i^{th} frequency (or i^{th} frequency band) received from the second external electronic device 320 is corrected.

For example, when it is determined that the audio signal in the i^{th} frequency (or i^{th} frequency band) is not corrected based on information related to the corrected frequency band received from the first external electronic device 300 and the second external electronic device 320, the audio processing circuit 412 (for example, the beam control module 604 of FIG. 6) may determine that beamforming for the i^{th} frequency (or i^{th} frequency band) is performed. For example, the state in which it is determined that the audio signal in the i^{th} frequency (or i^{th} frequency band) is not corrected may include the state in which the audio signal in the i^{th} frequency (or i^{th} frequency band) received from the first external electronic device 300 and the i^{th} frequency (or i^{th} frequency band) received from the second external electronic device 320 are not corrected.

According to an embodiment, when it is determined that beamforming is possible in the i^{th} frequency (or i^{th} frequency band) (for example, “Yes” of operation 901), the electronic device 101 may perform beamforming for the audio signal in the i^{th} frequency (or i^{th} frequency band) in operation 903. For example, beamforming may be performed based on a data-based beamforming scheme or a GSC-based beamforming scheme. For example, beamforming may be performed based on a beamforming parameter determined based on a beamforming result of the i^{th} frequency (or i^{th} frequency band) made at the previous time point (or in the previous frame).

According to an embodiment, the electronic device 101 may identify whether the audio signal is distorted by beamforming in operation 905. For example, when PLC is performed for the audio signal in the i^{th} frequency (or i^{th} frequency band) received from at least one of the first external electronic device 300 or the second external electronic device 320, the audio processing circuit 412 (for example, the beam control module 604 or the error detection module 608 of FIG. 6) may determine that the audio signal is distorted by beamforming. When PLC is not performed for the audio signal in the i^{th} frequency (or i^{th} frequency band) received from at least one of the first external electronic device 300 or the second external electronic device 320, the audio processing circuit 412 (for example, the beam control module 604 or the error detection module 608 of FIG. 6) may determine that the audio signal is not distorted by beamforming.

For example, when there is a frequency band (or frequency) in which power of the audio signal in the i^{th} frequency (or i^{th} frequency band) included in the output of the beamforming module 606 becomes higher than power of the audio signal in the i^{th} frequency (or i^{th} frequency band) input into the beamforming module 606 by a the error detection module 608 of FIG. 6) may determine that the audio signal is distorted by beamforming. For example, when there is no frequency band (or frequency) in which power of the audio signal in the i^{th} frequency (or i^{th} frequency band) included in the output of the beamforming module 606 becomes higher than power of the audio signal in the i^{th} frequency (or i^{th} frequency band) input into the beamforming module 606 by a predetermined reference value or more, the audio processing circuit 412 (for example, the error detection module 608 of FIG. 6) may determine that the audio signal is not distorted by beamforming.

According to an embodiment, when it is determined that beamforming is not possible in the i^{th} frequency (or i^{th} frequency band) (for example, “No” of operation 901), the electronic device 101 may select one of the audio signals in the i^{th} frequency (or i^{th} frequency band) received from the first external electronic device 300 and the second external electronic device 320 in operation 907. For example, the electronic device 101 may select an audio signal having a low noise level among the audio signals received from the first external electronic device 300 and the second external electronic device 320 corresponding to the i^{th} frequency (or i^{th} frequency band) in which beamforming is restricted.

According to an embodiment, the electronic device 101 may remove noise from the audio signal selected based on the noise level. The electronic device 101 may detect user's voice data in the audio signal from which noise included in the interval (for example, voice speaking interval) determined to have a user's voice is removed.

According to an embodiment, the electronic device 101 may repeatedly perform operations 901 to 907 of FIG. 9 for each frequency (or frequency band) included in the audio signal in a predetermined time interval (for example, frame) received from the external electronic devices 300 and 320 by the electronic device 101.

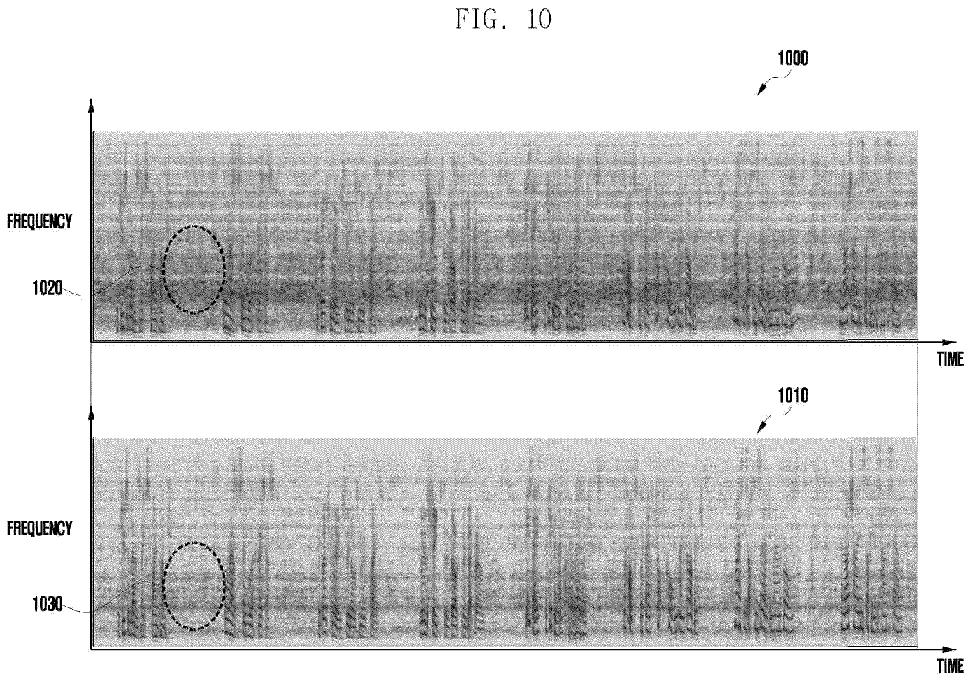

According to an embodiment, the electronic device 101 may detect voice data through beamforming based on audio signals collected through a plurality of microphones by each of a plurality of external electronic devices 300 and 320. In this case, since the electronic device 101 uses a plurality of microphones included in the plurality of external electronic devices 300 and 320, it is possible to increase the quality (for example, SNR) of the voice data by performing beamforming in a three-dimensional plane, as illustrated in FIG. 10.

FIG. 10 is a diagram illustrating an example of an audio signal acquired through beamforming by the electronic device according to various embodiments.

According to an embodiment referring to FIG. 10, the electronic device 101 may detect voice data through first beamforming 1000 based on audio signals collected through microphones of one external electronic device (for example, the first external electronic device 300 or the second external electronic device 320 of FIG. 3) wirelessly connected to the electronic device 101.

According to an embodiment, the electronic device 101 may detect voice data through second beamforming 1010 based on audio signals collected through microphones of external electronic devices (for example, the first external electronic device 300 or the second external electronic device 320 of FIG. 3) wirelessly connected to the electronic device 101.

According to an embodiment, a noise level 1020 included in the result of the performed first beamforming 1000 may be higher than a noise level 1030 included in the result of the performed second beamforming 1010. For example, the quality (for example, SNR) of the voice data in the case where the first beamforming 1000 is performed may include a first value (for example, about 8.49 dB). The quality (for example, SNR) of the voice data in the case where the second beamforming 1010 is performed may be improved to a second value (for example, about 18.67 dB) larger than the first value.

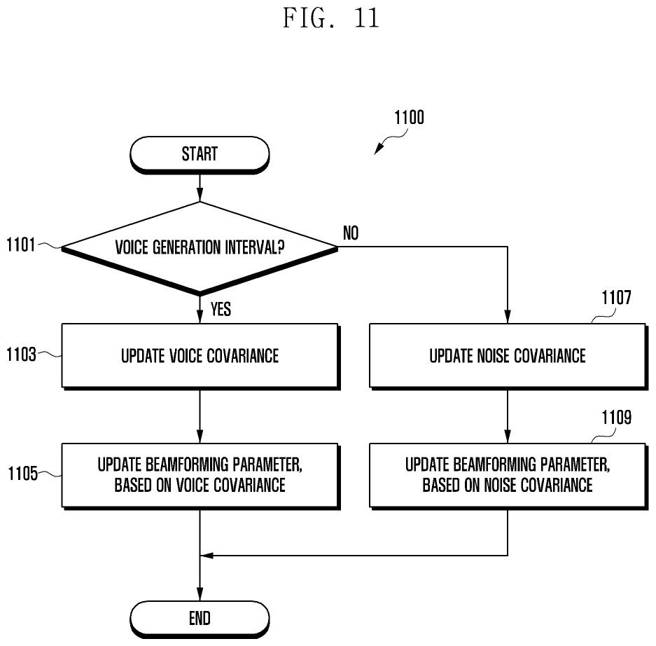

FIG. 11 is a flowchart 1100 illustrating an example process in which the electronic device updates a beamforming parameter according to various embodiments. For example, at least some of FIG. 11 may include the detailed operation for operation 811 of FIG. 8. In the following description, respective operations may be sequentially performed but the sequential performance is not necessary. For example, orders of the operations may be changed, and at least two operations may be performed in parallel. For example, the electronic device of FIG. 11 may be the electronic device 101 of FIG. 1, 2, 3, or 4.

According to an embodiment referring to FIG. 11, when it is determined that the audio signal is not distorted by beamforming (for example, “No” of operation 807 of FIG. 8), the electronic device (for example, the electronic device 101) may determine whether audio signals received from external electronic devices (for example, the first external electronic device 300 and the second external electronic device 320 of FIG. 3) are detected in a voice generation interval in operation 1101. For example, when information indicating the existence of the voice from at least one of the first external electronic device 300 or the second external electronic device 320 is acquired, the audio processing circuit 412 (for example, the VAD 602 of FIG. 6) may determine that there is the user's voice in the audio signals received from the external electronic devices 300 and 320. When information indicating that there is no voice and/or information indicating that the existence or nonexistence of a voice cannot be determined are acquired from the first external electronic device 300 and the second external electronic device 320, the audio processing circuit 412 (for example, the VAD 602 of FIG. 6) may determine that there is no user's voice in the audio signals received from the external electronic devices 300 and 320.

According to an embodiment, when it is determined that audio signals received from the external electronic devices (for example, the first external electronic device 300 and the second external electronic device 320 of FIG. 3) are detected in the voice generation interval (for example, “Yes” of operation 1101), the electronic device 101 may update a covariance for the voice, based on the audio signals received from the external electronic devices (for example, the first external electronic device 300 and the second external electronic device 320 of FIG. 3) in operation 1103. For example, when beamforming for the audio signal in an i^{th} frequency (or i^{th} frequency band) is performed, the audio processing circuit 412 (for example, the beam control module 604 of FIG. 6) may update the covariance vector for the voice, based on a voice component included in the audio signal in the i^{th} frequency (or i^{th} frequency band).

According to an embodiment, the electronic device 101 may update (or generate) a beamforming parameter, based on the covariance vector for the voice in operation 1105.

According to an embodiment, when it is determined that the audio signals received from the external electronic devices (for example, the first external electronic device 300 and the second external electronic device 320 of FIG. 3) are not detected in the voice generation interval (for example, “No” of operation 1101), the electronic device 101 may update a covariance vector for noise, based on the audio signals received from the external electronic devices (for example, the first external electronic device 300 and the second external electronic device 320 of FIG. 3) in operation 1107. For example, when beamforming for the audio signal in the i^{th} frequency (or i^{th} frequency band) is performed, the audio processing circuit 412 (for example, the beam control module 604 of FIG. 6) may update the covariance vector for the noise, based on a noise component included in the audio signal in the i^{th} frequency (or i^{th} frequency band).

According to an embodiment, the electronic device 101 may update (or generate) the beamforming parameter, based on the covariance vector for the noise in operation 1109.

According to an embodiment, the electronic device 101 may perform beamforming for the audio signals received from the first external electronic device 300 and the second external electronic device 320 of FIG. 3) at the next time point (or in the next frame) using the beamforming parameter updated (or generated) based on the covariance vector for the voice or the covariance vector for the noise.

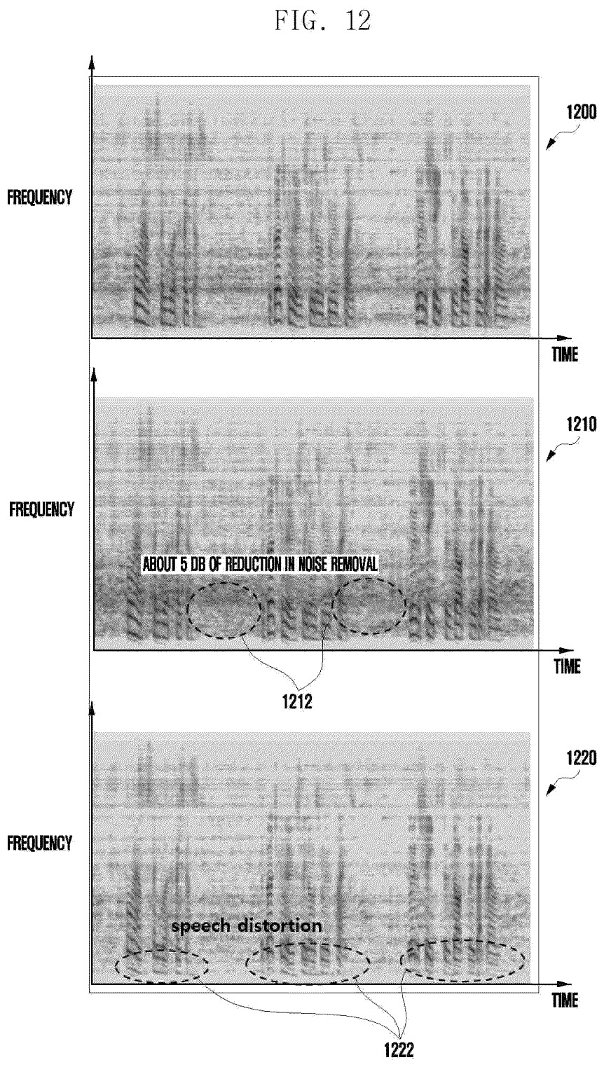

FIG. 12 is a diagram illustrating an example of an audio signal acquired through selective update of a beamforming parameter by the electronic device according to various embodiments.

According to an embodiment referring to FIG. 12, when the electronic device 101 performs beamforming, based on a beamforming parameter updated (or generated) based on audio signals determined to have a packet error, the quality of the audio signal may deteriorate by the beamforming. For example, when the electronic device 101 updates the beamforming parameter, based on the covariance vector for noise based on the audio signals determined to have the packet error in operation 1210, an amount of noise removal may be reduced (about 5 dB) in operation 1212 compared to the case where the beamforming parameter is updated based on the audio signals having no packet error in operation 1200. For example, when the electronic device 101 updates the beamforming parameter, based on the covariance vector for the voice based on the audio signals determined to have the packet error in operation 1220, voice data may be distorted in operation 1222 compared to the case where the beamforming parameter is updated based on the audio signals having no packet error in operation 1200.

According to an embodiment, the electronic device 101 may selectively update (or generate) the beamforming parameter, based on whether audio signals received from a plurality of external electronic devices 300 and 320 are distorted, in order to reduce distortion of the audio signals by beamforming. For example, when the audio signals received from the plurality of external electronic devices 300 and 320 have no packet error, the electronic device 101 may perform beamforming using a beamforming vector updated based on the audio signals received from the plurality of external electronic devices 300 and 320.

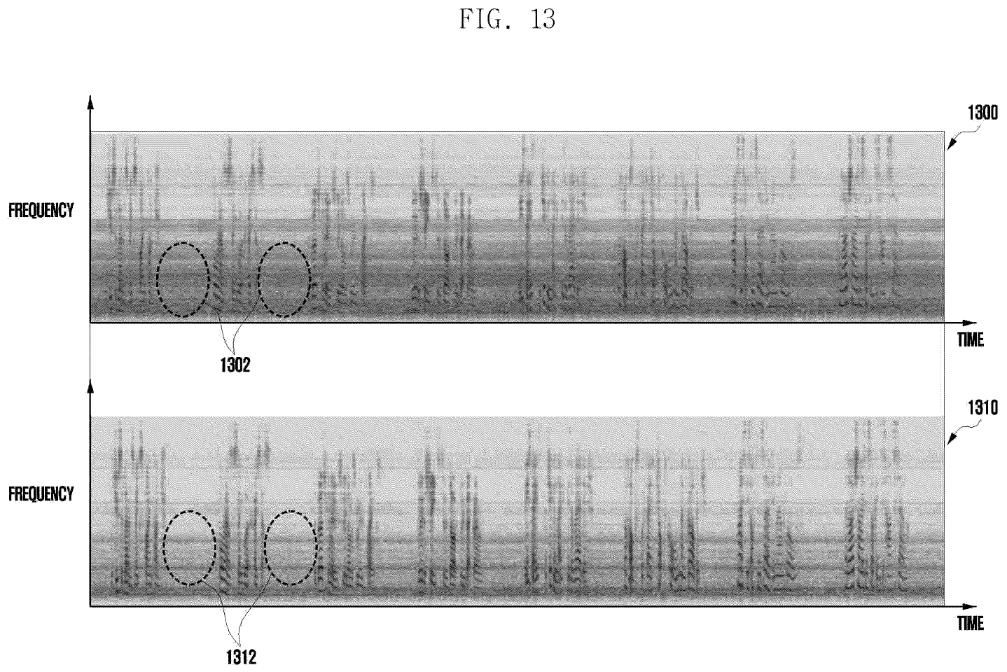

FIG. 13 is a diagram illustrating an example of an audio signal acquired through beamforming by the electronic device located in a first area according to

According to an embodiment referring to FIG. 13, the electronic device 101 may detect, in a first area (for example, in a car), voice data through beamforming based on audio signals collected through microphones of at least one external electronic device (for example, the first external electronic device 300 and/or the second external electronic device 320 of FIG. 3) wirelessly connected to the electronic device 101.

For example, the electronic device 101 may detect voice data through first beamforming 1300 based on audio signals collected through microphones of one external electronic device (for example, the first external electronic device 300 or the second external electronic device 320 of FIG. 3) wirelessly connected to the electronic device 101.

For example, the electronic device 101 may detect voice data through second beamforming 1310 based on audio signals collected through microphones of external electronic devices (for example, the first external electronic device 300 and the second external electronic device 320 of FIG. 3) wirelessly connected to the electronic device 101.

According to an embodiment, a noise level 1302 included in the result of the performed first beamforming 1300 may be higher than a noise level 1312 included in the result of the performed second beamforming 1310. For example, the quality (for example, SNR) of the voice data in the case where the first beamforming 1300 is performed may include a first value (for example, about 21.6 dB). The quality (for example, SNR) of the voice data in the case where the second beamforming 1310 is performed may be improved to a second value (for example, about 27.15 dB) larger than the first value.

According to an example embodiment, a method of operating an electronic device (for example, the electronic device 101 of FIG. 1, 2, 3, or 4) may include: receiving audio signals from a plurality of external electronic devices (for example, the first external electronic device 300 and the second external electronic device 320 of FIG. 3, or the external electronic device 420 of FIG. 4; identifying, in the audio signals, a frequency band in which beamforming is possible; performing beamforming for audio signals of the frequency band in which beamforming is possible; identifying whether the audio signals are distorted by the beamforming; based on determining that the audio signals are not distorted by the beamforming, updating a beamforming parameter, based on voice components or noise components included in the audio signals; and based on determining that the audio signals are distorted by the beamforming, restricting the update of the beamforming parameter.

According to an example embodiment, the beamforming parameter may be used for beamforming of an audio signal performed in a next time interval (or next frame).

According to an example embodiment, the identifying whether the audio signals are distorted may include: based on a packet loss concealment (PLC) operation for the audio signals of the frequency band in which beamforming is possible being performed, determining that the audio signals are distorted by the beamforming; and based on the PLC operation for the audio signals of the frequency band in which beamforming is possible not being performed, determining that the audio signals are not distorted by the beamforming.

According to an example embodiment, the identifying whether the audio signals are distorted may include: based on determining that power of the audio signals increases based on a beamforming result, determining that the audio signals are distorted by the beamforming; and based on determining that power of the audio signals decreases based on the beamforming result, determining that the audio signals are not distorted by the beamforming.

According to an example embodiment, the method of operating the electronic device may include based on determining that the external electronic devices are worn on a user's body part, identifying the frequency band in which beamforming is possible in audio signals received from the external electronic devices.

According to an example embodiment, the identifying the frequency band in which beamforming is possible may include: identifying, in the beamformed audio signals received from each of the external electronic devices, whether there is a frequency band updated based on another audio signal, based on a control signal received from the external electronic devices; determining the frequency band updated based on the another audio signal as a frequency band in which beamforming is restricted; and determining a frequency band that is not updated based on the another audio signal as the frequency band in which beamforming is possible.

According to an example embodiment, the method of operating the electronic device may include: removing noise from the audio signals in the frequency band in which beamforming is restricted and the beamforming result (e.g., audio signals detected using beamforming) for the frequency band in which beamforming is possible; and removing echo components from the audio signals from which the noise is removed.

According to an example embodiment, the updating the beamforming parameter may include: based on determining that the audio signals are not distorted by the beamforming, identifying whether a specified interval for the beamforming is a voice generation interval, based on a control signal received from the external electronic devices; based on the specified interval for the beamforming being the voice generation interval, updating a parameter related to the beamforming, based on the voice components included in the received audio signals; and based on the specified interval for the beamforming not being the voice generation interval, updating the parameter related to the beamforming, based on the noise components included in the audio signals.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
communication circuitry;
at least one processor, comprising processing circuitry; and
a memory storing instructions, wherein at least one processor, individually or collectively, is configured to execute the instructions, and to cause the electronic device to:
receive, via the communication circuitry, audio signals from external electronic devices,
identify, in the received audio signals, a frequency band in which beamforming is possible,
perform beamforming for audio signals of the frequency band in which beamforming is possible,
identify whether the audio signals are distorted by the beamforming,
based on determining that the audio signals are not distorted by the beamforming, update a beamforming parameter, based on voice components or noise components included in the received audio signals, and
based on determining that the audio signals are distorted by the beamforming, restrict the update of the beamforming parameter.

2. The electronic device of claim 1, wherein the beamforming parameter is configured to be used for beamforming of an audio signal performed in a next time interval.

3. The electronic device of claim 1, wherein at least one processor, individually and/or collectively, is configured to execute the instructions, and to cause the electronic device to:
based on a packet loss concealment (PLC) operation for the audio signals of the frequency band in which beamforming is possible being performed, determine that the audio signals are distorted by the beamforming; and
based on the PLC operation for the audio signals of the frequency band in which beamforming is possible not being performed, determine that the audio signals are not distorted by the beamforming.

4. The electronic device of claim 1, wherein at least one processor, individually and/or collectively, is configured to execute the instructions, and to cause the electronic device to:
based on determining that power of the audio signals increases based on a beamforming result, determine that the audio signals are distorted by the beamforming; and
based on determining that power of the audio signals decreases based on the beamforming result, determine that the audio signals are not distorted by the beamforming.

5. The electronic device of claim 1, wherein at least one processor, individually and/or collectively, is configured to execute the instructions, and to cause the electronic device to: based on determining that the external electronic devices are worn on a user's body part, identify the frequency band in which beamforming is possible in audio signals received from the external electronic devices.

6. The electronic device of claim 1, wherein the audio signals received from the external electronic devices comprise beamformed audio signals, based on audio signals collected via a plurality of microphones in each of the external electronic devices.

7. The electronic device of claim 6, wherein at least one processor, individually and/or collectively, is configured to execute the instructions, and to cause the electronic device to:
based on a control signal received from the external electronic devices, identify, in the beamformed audio signals received from each of the external electronic devices, whether there is a frequency band updated based on another audio signal;
determine the frequency band updated based on the another audio signal as a frequency band in which beamforming is restricted; and
determine a frequency band that is not updated based on the another audio signal as the frequency band in which beamforming is possible.

8. The electronic device of claim 7, wherein at least one processor, individually and/or collectively, is configured to execute the instructions, and to cause the electronic device to:
remove noise from the audio signals in the frequency band in which beamforming is restricted and the beamforming result for the frequency band in which beamforming is possible; and
remove echo components from the audio signals from which the noise is removed.

9. The electronic device of claim 1, wherein at least one processor, individually and/or collectively, is configured to execute the instructions, and to cause the electronic device to:
based on determining that the audio signals are not distorted by the beamforming, identify whether a specified interval for the beamforming is a voice generation interval, based on a control signal received from the external electronic devices;
based on the specified interval for the beamforming being the voice generation interval, update a parameter related to the beamforming, based on the voice components included in the received audio signals; and
based on the specified interval for the beamforming not being the voice generation interval, update the parameter related to the beamforming, based on the noise components included in the received audio signals.

10. The electronic device of claim 1, wherein the external electronic devices include a pair of wearable devices

11. A method of operating an electronic device, the method comprising:
receiving audio signals from a plurality of external electronic devices;
identifying, in the received audio signals, a frequency band in which beamforming is possible;
performing beamforming for audio signals of the frequency band in which beamforming is possible;
identifying whether the audio signals are distorted by the beamforming;
based on determining that the audio signals are not distorted by the beamforming, updating a beamforming parameter, based on voice components or noise components included in the received audio signals; and
based on determining that the audio signals are distorted by the beamforming, restrict the update of the beamforming parameter.

12. The method of claim 11, wherein the beamforming parameter is used for beamforming of an audio signal performed in a next time interval.

13. The method of claim 11, wherein the identifying of whether the audio signals are distorted comprises:
based on a packet loss concealment (PLC) operation for the audio signals of the frequency band in which beamforming is possible being performed, determining that the audio signals are distorted by the beamforming; and
based on the PLC operation for the audio signals of the frequency band in which beamforming is possible not being performed, determining that the audio signals are not distorted by the beamforming.

14. The method of claim 11, wherein the identifying of whether the audio signals are distorted comprises:
based on determining that power of the audio signals increases based on a beamforming result, determining that the audio signals are distorted by the beamforming; and
based on determining that power of the audio signals decreases based on the beamforming result, determining that the audio signals are not distorted by the beamforming.

15. The method of claim 11, further comprising, based on determining that the external electronic devices are worn on a user's body part, identifying the frequency band in which beamforming is possible in audio signals received from the external electronic devices.

16. The method of claim 11, wherein the updating of the beamforming parameter comprises:
based on determining that the audio signals are not distorted by the beamforming, identifying whether a specified interval for the beamforming is a voice generation interval, based on a control signal received from the external electronic devices;
based on the specified interval for the beamforming being the voice generation interval, updating a parameter related to the beamforming, based on voice components included in the received audio signals; and
based on the specified interval for the beamforming not being the voice generation interval, updating the parameter related to the beamforming, based on noise components included in the received audio signals.

17. The method of claim 11, wherein the audio signals received from the external electronic devices comprise beamformed audio signals, based on audio signals collected via a plurality of microphones in each of the external electronic devices.

18. The method of claim 17, wherein the identifying the frequency band in which beamforming is possible comprises:
based on a control signal received from the external electronic devices, identifying, in the beamformed audio signals received from each of the external electronic devices, whether there is a frequency band updated based on another audio signal;
determining the frequency band updated based on the another audio signal as a frequency band in which beamforming is restricted; and
determining a frequency band that is not updated based on the another audio signal as the frequency band in which beamforming is possible.

19. The method of claim 18, further comprising,
removing noise from the audio signals in the frequency band in which beamforming is restricted and the beamforming result for the frequency band in which beamforming is possible; and
removing echo components from the audio signals from which the noise is removed.

20. A non-transitory computer-readable storage medium for storing one or more programs comprising:
the one or more programs include instructions that, when individually or collectively executed by at least one processor of an electronic device, cause the electronic device to:
receive audio signals from a plurality of external electronic devices,
identify, in the received audio signals, a frequency band in which beamforming is possible,
perform beamforming for audio signals of the frequency band in which beamforming is possible,
identify whether the audio signals are distorted by the beamforming,
based on determining that the audio signals are not distorted by the beamforming, update a beamforming parameter, based on voice components or noise components included in the received audio signals, and
based on determining that the audio signals are distorted by the beamforming, restrict the update of the beamforming parameter.
